(19) United States
(12) Patent Application Publication
(10) Pub. No.: US 2011/0062190 A1
(43) Pub. Date: Mar. 17, 2011

(54) BULK PRODUCT DISPENSER HAVING A CONTAINER-ACTIVATED DISPENSING ACTUATOR RELEASE ASSEMBLY

(75) Inventors: SCOTT JOHNSON, LITTLE ROCK, AR (US); RONALD BRUNDICK, ROLAND, AR (US)

(73) Assignee: TRADE FIXTURES, LLC, LITTLE ROCK, AR (US)

(21) Appl. No.: 12/879,463

(22) Filed: Sep. 10, 2010

Related U.S. Application Data
(60) Provisional application No. 61/241,436, filed on Sep. 11, 2009.

(51) Int. Cl. B67D 7/06; B67B 1/00

(52) U.S. Cl. 222/517; 222/153.14

(57) ABSTRACT

A dispensing actuator locking assembly for a bulk inventory dispenser. The dispenser comprises a housing, a lockable dispensing actuator pivotally connected to the housing, and a gate connected to the dispensing actuator and adapted to pivot between a closed position and an open position when a receptacle is properly staged beneath the dispenser. When properly staged, a receptacle urges a locking member to disengage the dispensing actuator thereby unlocking it. When the dispensing actuator is in an unlocked condition stored inventory is selectively dispenses through an opening in the housing. The dispensing actuator cannot be accidentally actuated unless and until the locking assembly is purposefully disengaged by the user of the dispenser when a receptacle is in place to catch and store the dispensed inventory.

This application claims priority to U.S. Provisional Patent Application No. 61/241,436, filed Sep. 11, 2009, the entire contents of which are hereby incorporated by reference thereto.

### FIELD

The present invention relates generally to a bulk inventory dispensing apparatus and, more particularly, to a gravity-fed dispensing apparatus with a locking dispensing actuator. The apparatus allows bulk inventory stored in a dispensing bin to flow under the force of gravity upon release of a dispensing actuator locking portion of the bin thereby enabling rotation of the dispensing actuator. Once released, the dispensing actuator can then be articulated to permit stored inventory to be dispensed through an outlet portion of the bin into a staged receptacle.

### BACKGROUND

Gravity fed bins for dispensing bulk inventory are used to dispense a wide variety of materials having a range of sizes and aggregate make-ups as diverse as hardware components, e.g., nuts and bolts, to retail grocery food, e.g., pastas, cereals, nuts, coffee (either beans or ground), dried soup mixes, candies, spices, and the like. Generally, such a bin is comprised of a hopper-type enclosure having an inlet at an upper end utilized to fill the enclosure with bulk inventory, an outlet or chute at its lower end utilized to dispense the material, and a flow control device located intermediate the upper and lower openings and controlled by a manually-actuated gate mechanism. This arrangement, in turn, permits manipulation of the amount of inventory being dispensed during the interval the handle or other control device is actuated. In operation, as the inventory is being dispensed, the force of gravity causes the portion stored above in the cavity to progressively migrate towards the lower end to replace the void left as portions of the inventory are dispensed. These types of bins generally include a downwardly angled or curving inner floor surface wall within the cavity that forms a slide to channel the stored inventory into a receptacle adjacent the outlet gate. Examples of prior art gravity fed bins can be found in the above-mentioned U.S. patents to Elmore, U.S. Pat. No. 4,903,866 to Loew, NewLeaf Designs' Vita-Bin® gravity bin product, and BestBins Corporation's gravity bins product.

Heretofore, the one means for dispensing such stored bulk inventory was to employ a bulk food dispenser generally known as a “scoop bin.” As the name suggests, a scoop bin typically comprises a plastic bin, often having a hinged lid that is lifted to provide the consumer access to the stored contents. A hand scoop is then employed to gather the bulk product for placement into a container. While scoop bins are effective for dispensing a wider variety of product than a gravity type dispenser, they suffer from several major disadvantages, particularly in the area of hygiene, because of the contamination that can take place in these types of dispensers. Sources of contamination include germs that may be attached to the scoop or scoop handle being transferred to the stored product during dispensing or from external debris falling into the bin cavity when the bin's lid is lifted. Lastly, since the nature of scoop bins requires their openings to be located closer to the floor for access reasons, they are generally within the reach of children and others who are not hesitant to reach into the unsecured bins with potentially unclean hands in order to extract a sample, or even play with the bin contents. In addition, scoop bins also suffer from inventory shrinkage, due to pilferage and accidental spillage.

Gravity-fed bins offer a multitude of advantages compared to other dispensing means, such as scoop bins, including convenience, ease of use and hygiene. However, the ease in which inventory can be dispensed from gravity-fed dispensers sometimes works against itself in that the release mechanism may be easily actuated and thus dispense inventory through the outlet regardless of whether there is a receptacle in place to catch it. This type of dispensing may be accidental, such as a child in a grocery cart tugging on a bin handle, or less so in the case of pilferage or pranks emanating from a portion of grocery clientele and is often referred to as “shrink” or “shrinkage.” In addition to accidental shrink, once a customer dispenses the bulk inventory into a container, all or some part of the dispensed inventory may be consumed by the customer prior to checking out. If consumed prior to being weighed by the retailer for payment, the amount eaten by the consumer amounts to shrink.

Bulk inventory shrinkage adversely affects a grocery retailer in a number of ways. First there is the cost of replacing the lost inventory that has left the gravity-fed bin without payment. Second, shrinkage stemming from accidental spills can make a mess that must be quickly cleaned up. Thus, there remains a need for a reliable, clean and easy to operate bulk inventory dispenser that prevents the dispenser from operating accidentally and once dispensed the inventory is stored in a manner to discourage a customer from eating it prior to check out, thus reducing shrinkage.

### SUMMARY

The invention disclosed herein addresses and overcomes the shortcomings inherent in providing the consuming public access to self-serve, gravity-fed bulk inventory bins. The present invention provides a means for locking a dispensing actuator until a user of the bin properly slides a receiving receptacle into a receiver located beneath the outlet. Once the receptacle is properly staged the dispensing actuator is unlocked, allowing stored inventory to be dispensed into the receptacle. Once the desired amount of inventory is placed into the receptacle the user releases the dispensing actuator, removes the receptacle from the receiver and places a lid onto the receptacle. Once it is placed in a sealed container dispensed inventory has a much better chance of being be taken to the checkout and paid for without undue shrink.

The bulk product dispenser with receptacle activated dispensing actuator release according to the present invention is preferably constructed of molded plastic, such as polycarbonate, but other moldable or machinable materials and color configurations are anticipated. For food related dispensers, it is also preferable to utilize materials that have been approved by the U.S. Food and Drug Administration and constructed in accordance with food service specifications issued by NSF Int'l of Ann Arbor, Mich.

One aspect of the present disclosure is a locking means for a dispenser of stored bulk inventory. The dispenser comprises a housing, a lower outlet in the housing, a dispensing actuator pivotally connected to the housing, a gate connected to the dispensing actuator and adapted to pivot between a closed position and an open position between a storage cavity and a dispensing cavity within the dispenser, a locking mechanism in communication with the dispensing actuator to prevent its unintentional actuation, an actuator arm proximate the outlet and coupled to the locking mechanism, a receiving container for securing the dispensed inventory for purchase. When a consumer properly places a receptacle into a predetermined position relative to the outlet, the receptacle triggers a releasing actuator, thereby releasing the locking mechanism and allowing the bulk inventory to flow from the dispenser through an opening in the housing and ultimately into the receiving container.

Another aspect of the disclosure is a tamper resistant, locking lid for a bulk inventory receiver for securing dispensed inventory in a receptacle and thus preventing shrinkage.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a side elevation of a gravity-fed, bulk inventory dispenser in the art according to U.S. Pat. No. 6,241,123;

FIG. 2 is a perspective view of a bulk product dispenser according to an embodiment of the present invention, showing a receptacle receiver located beneath an outlet of the dispenser while the dispensing actuator is in a locked, non-dispensing condition;

FIG. 3 is a front end elevational view of the bulk product dispenser of FIG. 2 with the dispensing actuator in a locked condition according to an embodiment of the present invention;

FIG. 4 is a side elevational view of the bulk product dispenser of FIG. 3;

FIG. 5 is a perspective view of the dispenser of FIG. 2 according to an embodiment of the present invention, showing the receptacle receiver located beneath an outlet of the dispenser while the dispenser is in an unlocked, dispensing condition;

FIG. 6 is a front end elevational view of the bulk product dispenser of FIG. 5 in an unlocked condition;

FIG. 7 is a side elevational view of the bulk product dispenser of FIG. 6; and

FIGS. 8A through 8D show the bulk product dispenser of FIG. 2 dispensing product.

### DETAILED DESCRIPTION

In the discussion that follows, like reference numeral are used to refer to like elements in the various figures.

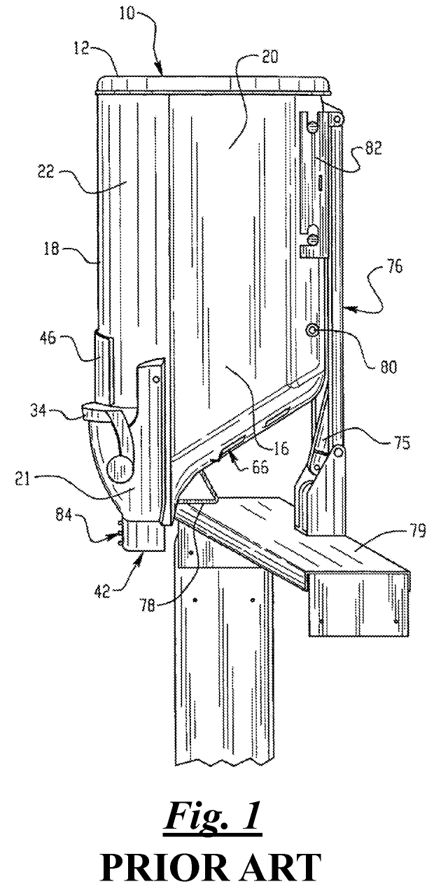

A gravity-fed, bulk inventory dispenser 10 as available in the art from Trade Fixtures, LLC of Little Rock, Ark. is shown in FIG. 1. Dispenser 10 includes a housing 18 for storing bulk product. Housing 18 is shown mounted to a base 79 via mounting arm 76. As can be seen, a dispensing area 21 is contiguous to an output portal 42 which is shown fitted with a set of stationary bag grip ribs at 84. Housing 18 may also include a detachable front portion 22 to provide access to a portion of the interior of dispenser 10 for service and maintenance.

A lid 12 fits atop housing 18 to provide selectable access to the interior of the housing for refilling depleted bulk inventory. Lid 12 may be removable or hinged to housing 18, and may be held in place in any conventional manner, such as a press-fit using mating projections on the lid and/or the housing.

A dispensing actuator 34 is pivotally attached to housing 18. Although dispensing actuator 34 is shown in the form of a handle, additional actuator devices are anticipated which may be manually actuated to articulate a gate that holds back the stored bulk materials. Such additional actuators include, without limitation, an actuator combined with an output portal of the gravity-fed bin. An internal gate (not shown) is arranged to selectively block and unblock an opening (not shown, but internal to the housing proximate dispensing arm 21) between the cavity 16 of housing 18 and output portal 42. The gate is mechanically coupled to dispensing actuator 34 such that the gate, if unimpeded, raises when the dispensing actuator is pivoted downwardly. Under this condition, bulk inventory stored within the cavity 16 of bulk inventory dispenser 10 is permitted to flow from within the cavity, through output portal 42 and, preferably, into a consumer guided receptacle (not shown). For so long as the opening is blocked by the gate, bulk inventory stored in bulk inventory dispenser 10 is prevented from being discharged from the outlet.

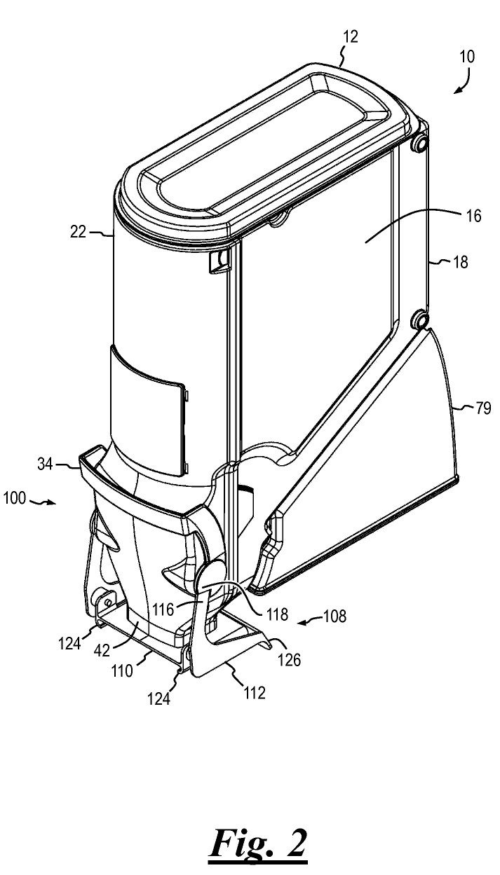

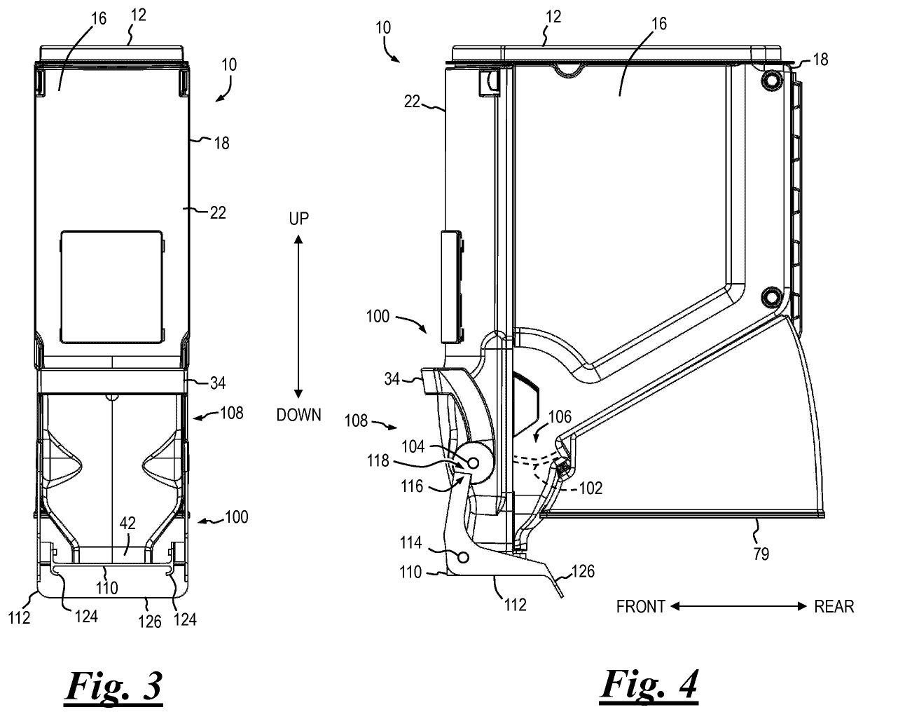

Referring now to FIGS. 2 through 7, details of an embodiment of a dispensing portion 100 of the present disclosure are shown according to an embodiment of the present invention. Dispensing actuator 34 and a gate 102 are held in a predetermined, closed position by a first biasing element 104 such that the gate blocks the flow of stored inventory through an opening passage 106 when the dispensing actuator is not being actuated. First biasing element 104 may be any suitable structure effective to hold dispensing actuator 34 in the predetermined position including, without limitation, elastic materials, helical springs, torsion springs and leaf springs.

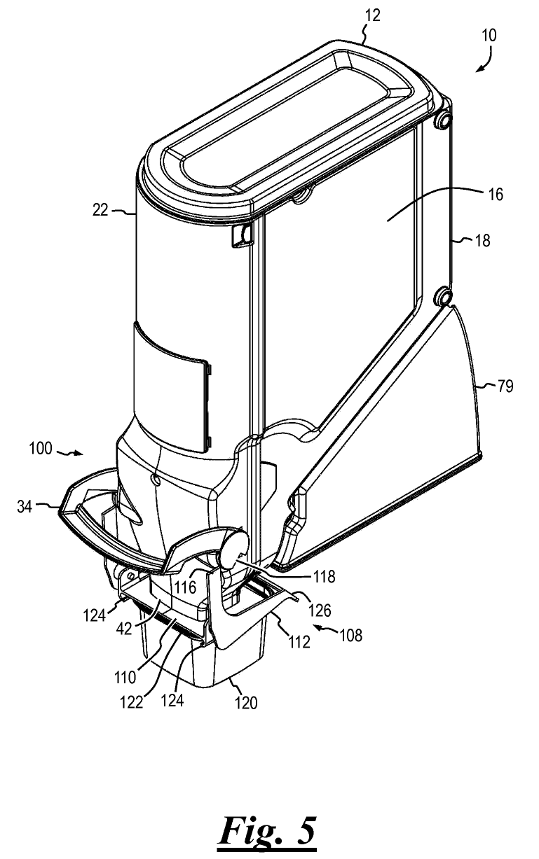

With continued reference to the combination of FIGS. 2 through 7 a dispensing actuator release assembly 108 is depicted in both a locked position (FIGS. 2 through 4) and an unlocked position (FIGS. 5 through 7). According to the disclosed embodiment, the dispensing actuator release assembly 108 comprises a receiver 110 mounted in a position beneath outlet 42. An actuator arm 112 is biased in a downward position by a second biasing element 114 including, without limitation, elastic materials, helical springs, torsion springs and leaf springs. When at rest, an upper termination 116 of actuator arm 112 impedes the rotation of dispensing actuator 34 by engaging a corresponding cutout portion 118 in the dispensing actuator, such as a slot or a notch. It is preferable, but not mandatory, that the actuator arm 112 and the dispensing actuator 34 each include two terminations 116 and cutout portions 118, respectively, located on opposing sides of the output portal 42.

Dispensing actuator release assembly 108 is depicted in a locked position in FIGS. 2 through 4. When at rest as shown, upper termination 116 of actuator arm 112 engages cutout portion 116 of dispensing actuator 34, thereby impeding rotation of the dispensing actuator and thus deterring movement of gate 102 away from passage 106.

Referring next to FIGS. 5 through 7, a user first directs a receptacle 120 into receiver 110. In the disclosed embodiment, receptacle 120 is constructed to include a circumferential lip 122. Receiver 110 has two slides 124 corresponding to the width of the body of the 120. Thus, when receptacle 120 is guided into receiver 110 and pushed inwardly, it becomes fully supported within the receiver by the lip 122 engaging the slide 124.

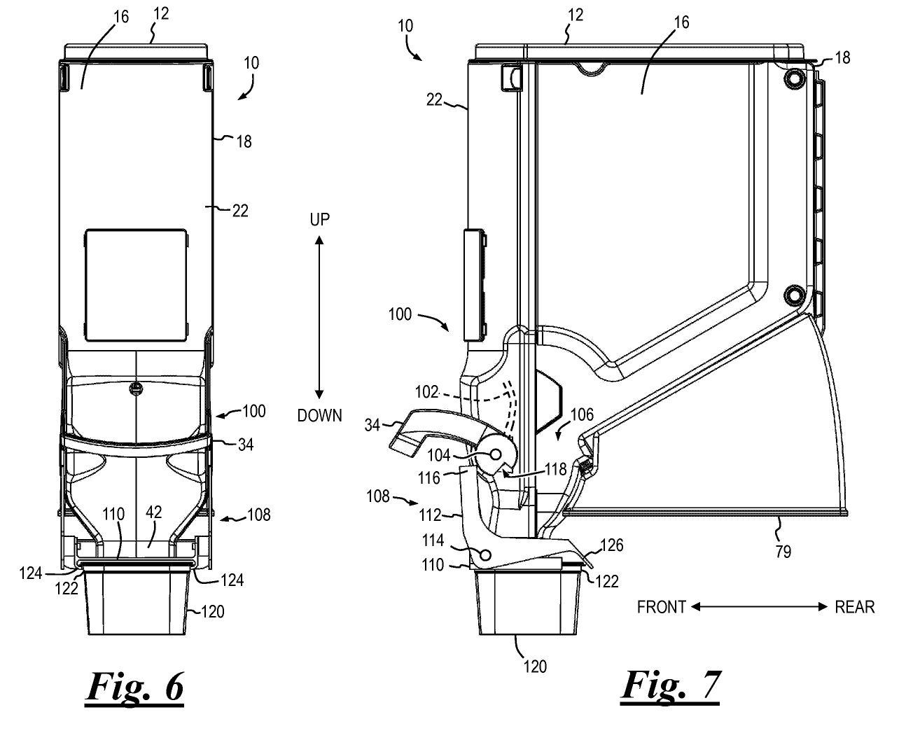

Located near an end of slide 124, a lever portion 126 of actuator arm 112 extends below receiver 110. When a receptacle 120 is fully staged into receiver 110, as at FIG. 7, lip 122 has slidingly engaged lever portion 126, thus urging actuator arm 112 downwardly. In so doing, the upper termination 116 of actuator arm 112 is urged away from cutout portion 118 of dispensing actuator 34 (FIG. 7) which served to impede it from rotational travel and permits the dispensing actuator to be pivoted or pulled forward. At this unlocked stage when dispensing actuator 34 is pulled by the user, it rotates and progressively moves gate 102 away from passage 106, allowing bulk inventory to flow through the opening for dispensing through outlet 42 into receptacle 120. Dispensing actuator 34 may be repeatedly actuated by the user until a desired amount of bulk inventory is dispensed into the receptacle 120. Once the desired amount of dispensed inventory has entered receptacle 120 the user returns dispensing actuator 34 into its upward (non-dispensing) position and then removes the receptacle, thereby reactivating the dispensing actuator release assembly 108 and disabling further dispensing actuator rotation until a receptacle once again is properly staged within receiver 110 in the manner described above.

In addition to using an actuator arm 112 cooperatively with a receiver 110 and their respective interference with aspects of dispensing actuator 34 in order to prevent its rotation, other dispensing actuator locking arrangements are anticipated by the inventors within the scope of the invention. As a non-limiting example, an actuator may be located on a portion of the dispensing actuator 34 itself and provide interference with the rotation of the dispensing actuator until actuated. Likewise, an actuable safety could be employed at a position on the body of the dispensing bin. Only by moving or holding the safety into an unlocked condition could dispensing actuator 34 be rotated and bulk inventory dispensed.

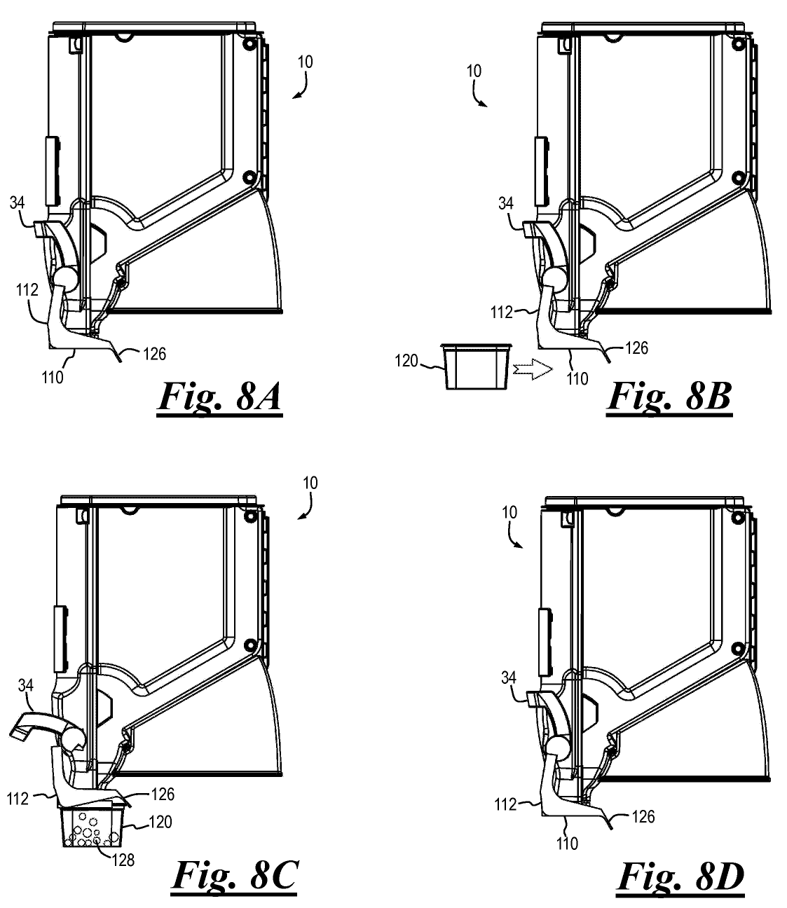

FIGS. 8A through 8D illustrate the dispenser 10 of the present invention in operation. Firstly, FIG. 8A shows dispenser 10 with dispensing actuator release assembly 108 in its locked position, deterring movement of dispensing actuator 34 and gate 106. In FIG. 8B, a user first places a receptacle 120 into receiver 110. As shown in FIG. 8C, actuator arm 112 lever portion 126 has been urged downwardly by receptacle 120 being fully engaged with receiving portion 110. Accordingly, dispensing actuator 34 is now unlocked and is free to rotate. At this unlocked stage when dispensing actuator 34 is pulled by the user, it rotates and progressively moves gate 102 away from passage 106, allowing bulk inventory 128 to flow through the passage for dispensing. Once the desired amount of bulk inventory 128 has been dispensed the user releases dispensing actuator 34 and removes receptacle 120, thereby causing dispensing actuator 34 to once again be locked from rotating by the re-engagement of the upper terminating portion 116 of actuator arm 112 and the cutout 118 of dispensing actuator 34.

While this invention has been shown and described with respect to a detailed embodiment thereof, it will be understood by those skilled in the art that changes in form and detail thereof may be made without departing from the scope of the claims of the invention.

What is claimed is:

1. A dispenser for stored bulk inventory, comprising:
a generally hollow housing having a cavity;
a lower opening in the housing, the opening forming an output portal;
a dispensing actuator pivotally connected to the housing;
a gate connected to the dispensing actuator and adapted to pivot between a closed position and an open position within the dispenser;
a first biasing element biasing the dispensing actuator to a non-dispensing orientation and further biasing the gate to a non-dispensing position;
a receiver positioned below the output portal;
an actuator arm pivotably coupled to the housing and pivotable between a first position engaging the dispensing actuator and a second position away from the dispensing actuator; and
a second biasing element biasing the actuator arm into engagement with the dispensing actuator,
the dispensing actuator being in a locked condition when the actuator arm is engaged thereto, the dispensing actuator further being in an unlocked condition when the actuator arm is urged away from the dispensing actuator by a receptacle engaging the receiver.

2. The dispenser of claim 1, further comprising:
an upper termination in the actuator arm; and
a cutout portion formed in the dispensing actuator,
the upper termination and the cutout portion being sized and shaped for engagement together.

3. The dispenser of claim 1 wherein the first biasing element is one of an elastic material, a helical spring, a torsion spring and a leaf spring.

4. The dispenser of claim 1 wherein the second biasing element is one of an elastic material, a helical spring, a torsion spring and a leaf spring.

5. The dispenser of claim 1, further comprising:
a second opening in the housing, the second opening being in communication with the cavity of the housing; and
a lid selectably closing off the second opening.

6. The dispenser of claim 1, wherein the housing includes a detachable front portion.

7. The dispenser of claim 1, further including a base to which the housing is attached.
